(19) United States
(12) Patent Application Publication
(10) Pub. No.: US 2025/0313760 A1
(43) Pub. Date: Oct. 9, 2025

(54) RADIAL FLOW MOVING BED REACTOR FOR CATALYTIC CRACKING OF LIGHT HYDROCARBONS

(71) Applicant: Chevron U.S.A. Inc., San Ramon, CA (US)

(72) Inventors: Huping Luo, Moraga, CA (US); Christopher Declan Lane, Kensington, CA (US); Xiaoying Ouyang, El Cerrito, CA (US)

(21) Appl. No.: 19/034,954

(22) Filed: Jan. 23, 2025

Related U.S. Application Data
(60) Provisional application No. 63/574,434, filed on Apr. 4, 2024.
(60) Provisional application No. 63/648,495, filed on May 16, 2024.

(51) Int. Cl. C10G 11/16; B01J 8/08; B01J 8/12

(52) U.S. Cl. CPC C10G 11/16; B01J 8/085; B01J 8/087; B01J 8/12; B01J 2208/00398; B01J 2208/00769

(57) ABSTRACT

A system includes a radial flow moving bed reactor configured to flow a first heated catalyst solid stream and fresh catalyst by gravity through the reactor and form a moving catalyst bed. The reactor is also configured to flow a light hydrocarbon feed stream downwards so that the light hydrocarbon feed stream flows radially inward or outward through the moving catalyst bed and contacts the first heated catalyst solid stream at a temperature sufficient to crack the light hydrocarbon feed stream to produce hydrogen and a spent catalyst stream comprising catalyst particles and solid carbon. A riser is connected to the reactor and combusts the spent catalyst stream to produce a mixture of a second heated catalyst solid stream and a heated gas effluent. A separator is connected to the reactor and the riser and separates the second heated catalyst solid stream from the heated gas effluent.

### PRIORITY CLAIM

The present application claims priority to U.S. Provisional Patent Application No. 63/648,495, entitled “Radial Flow Moving Bed Reactor for Catalytic Cracking of Light Hydrocarbons,” filed May 16, 2024, and to U.S. Provisional Patent Application Ser. No. 63/574,434, entitled “Reactor Design for Light Hydrocarbon Catalytic Cracking to Produce Hydrogen and High Value Solid Carbon,” filed Apr. 4, 2024, the content of each of which are incorporated by reference herein in their entirety.

### BACKGROUND

Catalytic cracking of light hydrocarbons such as, for example, methane, ethane, natural gas, etc., can produce “blue” hydrogen and solid carbon without producing carbon dioxide (CO₂) and hence with much lower carbon intensity than current technologies, such as steam methane reforming (SMR) with or without carbon capture sequestration (CCS). Leveraging conventional natural gas assets and distribution infrastructure, natural gas pyrolysis allows for producing low-cost, blue hydrogen at a production site or at a customer site near liquefied natural gas (LNG) receiving terminals to supply affordable hydrogen with significantly reduced transportation cost.

### SUMMARY

In accordance with an illustrative embodiment, a radial flow moving bed reactor system comprises:
a radial flow moving bed reactor configured to flow a first heated catalyst solid stream and fresh catalyst comprising catalyst particles by gravity through the radial flow moving bed reactor to an exit point of the radial flow moving bed reactor, wherein the first heated catalyst solid stream and the fresh catalyst form a moving catalyst bed in the radial flow moving bed reactor, wherein the radial flow moving bed reactor is further configured to flow a light hydrocarbon feed stream downwards in a manner so that the light hydrocarbon feed stream flows radially inward or radially outward through the moving catalyst bed and thereby contacts the first heated catalyst solid stream at a temperature sufficient to crack the light hydrocarbon feed stream to produce a product effluent comprising hydrogen and a spent catalyst stream comprising catalyst particles and solid carbon,
a riser operatively connected to a bottom portion of the radial flow moving bed reactor, the riser being configured to combust the spent catalyst stream comprising catalyst particles and solid carbon to produce a mixture of a second heated catalyst solid stream and a heated gas effluent, and
a separator operatively connected to a top portion of the radial flow moving bed reactor and a top portion of the riser, the separator being configured to separate the second heated catalyst solid stream from the heated gas effluent.

In accordance with another illustrative embodiment, a continuous process comprises:
flowing a heated catalyst solid stream and fresh catalyst comprising catalyst particles into a radial flow moving bed reactor, wherein the heated catalyst solid stream and fresh catalyst move by gravity through the radial flow moving bed reactor to an exit point of the radial flow moving bed reactor, wherein the heated catalyst solid stream and fresh catalyst form a moving catalyst bed in the radial flow moving bed reactor, and
flowing a light hydrocarbon feed stream downwards into the radial flow moving bed reactor in a manner so that the light hydrocarbon feed stream flows radially inward or radially outward through the moving catalyst bed and thereby contacts the heated catalyst solid stream at a temperature sufficient to crack the light hydrocarbon feed stream to produce a product effluent comprising hydrogen and a spent catalyst stream comprising catalyst particles and solid carbon.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawings can be applied to alternate processes and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements. In the accompanying drawings:

FIG. 1A illustrates a schematic diagram of a system with a radial flow moving bed reactor combined with a riser for use in catalytic cracking a light hydrocarbon feed stream flowing radially outward in the presence of a heated catalyst solid stream to produce a product effluent including hydrogen and a spent catalyst stream including catalyst particles and solid carbon, according to an illustrative embodiment.

FIG. 1B illustrates a schematic diagram of the system of FIG. 1A with a radial flow moving bed reactor having an internal heater combined with a riser for use in catalytic cracking a light hydrocarbon feed stream flowing radially outward in the presence of a heated catalyst solid stream to produce a product effluent including hydrogen and a spent catalyst stream including catalyst particles and solid carbon, according to an illustrative embodiment.

FIG. 2A illustrates a schematic diagram of a system with a radial flow moving bed reactor combined with a riser for use in catalytic cracking a light hydrocarbon feed stream flowing radially inward in the presence of a heated catalyst solid stream to produce a product effluent including hydrogen and a spent catalyst stream including catalyst particles and solid carbon, according to an illustrative embodiment.

FIG. 2B illustrates a schematic diagram of a system of FIG. 2A with a radial flow moving bed reactor having an internal heater combined with a riser for use in catalytic cracking a light hydrocarbon feed stream flowing radially outward in the presence of a heated catalyst solid stream to produce a product effluent including hydrogen and a spent catalyst stream including catalyst particles and solid carbon, according to an illustrative embodiment.

### DETAILED DESCRIPTION

Various illustrative embodiments described herein are directed to radial flow moving bed reactor systems and processes for catalytic cracking of light hydrocarbons to produce a product effluent comprising hydrogen and a spent catalyst stream including catalyst particles and solid carbon. The conversion of light hydrocarbons into added value chemicals, materials and fuels offers one alternative to crude.

Direct conversion of light hydrocarbons such as methane can produce solid carbon of various morphologies, such as amorphous carbon, graphite, carbon nanotube with different applications and at the same time produce hydrogen that can be used to make, for example, fuel. Hydrogen is one of the more important options for future clean energy. As mentioned above, catalytic cracking of light hydrocarbons such as, for example, methane, ethane, natural gas, etc., can produce hydrogen along with solid carbon as a by-product without producing carbon dioxide (CO₂) and hence with much lower carbon intensity than current technologies, such as steam methane reforming (SMR) with or without carbon capture sequestration (CCS).

The process development of the catalytic cracking of light hydrocarbon however is still in its early stage, albeit rapidly gaining momentum due to increased efforts from industrial and academic sources. However, the reactor design and associated engineering difficulties are known to be the main hurdles to develop a cost-effective process for producing high quality hydrogen and high value carbon products with proper morphology, such as carbon nanotubes.

In view of these challenges, there is a need for solutions that produce high quality blue hydrogen and value-added solid carbon from light hydrocarbons in a cost-effective manner. In addition, it would be advantageous for the reactor design for this process to have the capability to (1) provide the reaction heat needed to maintain an optimized temperature profile to achieve high conversion, and (2) utilize the solid carbon by-product in the process. In some aspects, it would be advantageous to also regenerate and recycle the catalyst being used. In some aspects, it would be advantageous to utilize renewable electricity or a heat exchanger in the reactor to provide the reaction heat needed to maintain an optimized temperature profile to achieve high conversion with little to no carbon dioxide generation. It would further be advantageous if such solutions are more energy efficient than existing approaches to produce high quality hydrogen and value-added solid carbon with the desired morphology, such as carbon nanotubes.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

A “fresh catalyst” as used herein denotes a catalyst which has not previously been used in a catalytic process.

A “spent catalyst” as used herein denotes a catalyst that has less activity at the same reaction conditions (e.g., temperature, pressure, inlet flows) than the catalyst had when it was originally exposed to the process. This can be due to a number of reasons, several non-limiting examples of causes of catalyst deactivation are coking or carbonaceous material sorption or accumulation, steam or hydrothermal deactivation, metals (and ash) sorption or accumulation, attrition, morphological changes including changes in pore sizes, cation or anion substitution, and/or chemical or compositional changes.

A “regenerated catalyst” as used herein denotes a catalyst that had become spent, as defined above, and was then subjected to a process that increased its activity to a level greater than it had as a spent catalyst. This may involve, for example, reversing transformations or removing contaminants outlined above as possible causes of reduced activity. The regenerated catalyst typically has an activity that is equal to or less than the fresh catalyst activity.

The term “zone” can refer to an area including one or more equipment items and/or one or more sub-zones. Equipment items can include one or more reactors or reactor vessels, absorption units, separation vessels, distillation towers, heaters, heat exchangers, pipes, pumps, compressors, and controllers. Additionally, an equipment item, such as a reactor, dryer, or vessel, can further include one or more zones or sub-zones.

The term “effluent” refers to a stream that is passed out of a reactor, a reaction zone, or an absorption unit following a particular reaction or separation. Generally, an effluent has a different composition than the stream that entered the reactor, reaction zone, or absorption unit. It should be understood that when an effluent is passed to another component or system, only a portion of that effluent may be passed. For example, a slipstream may carry some of the effluent away, meaning that only a portion of the effluent may enter the downstream component or system.

The term “primarily” shall be understood to mean an amount greater than 50%, e.g., 50.01 to 100%, or any range between, e.g., 51 to 95%, 75% to 90%, at least 60%, at least 70%, at least 80%, etc.

The non-limiting illustrative embodiments described herein overcome the drawbacks discussed above by providing radial flow moving bed reactor systems and processes for catalytic cracking a light hydrocarbon feed stream to, for example, a product effluent comprising hydrogen and a spent catalyst stream including catalyst particles and solid carbon by employing a reactor design which utilizes the solid carbon for providing reaction heat needed to maintain an optimized temperature profile to achieve high conversion.

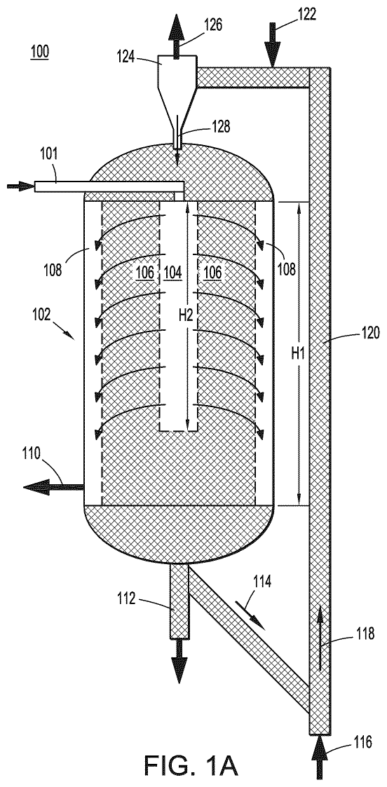

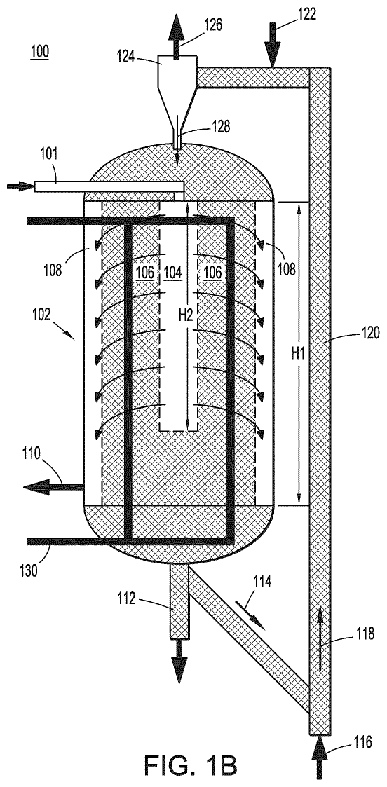

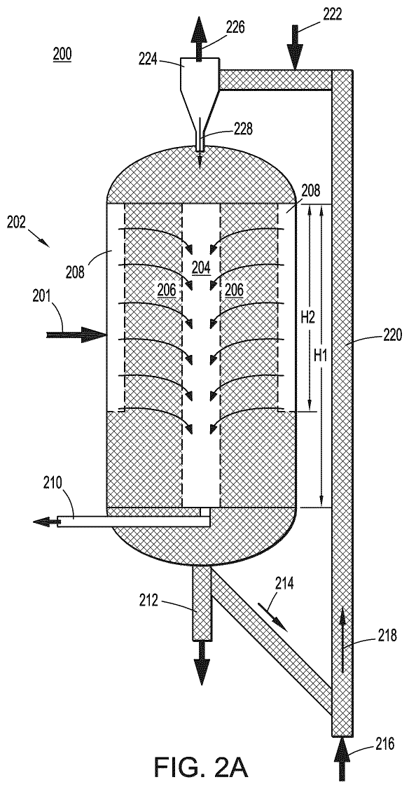

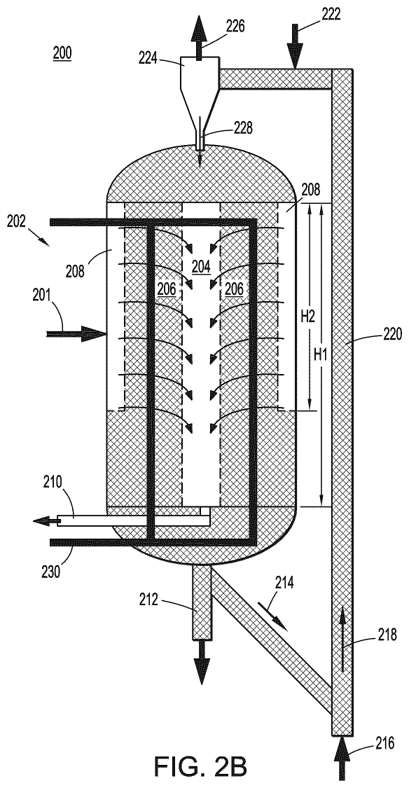

The non-limiting illustrative embodiments of the present disclosure will be specifically described below with reference to the accompanying drawings. For the purpose of clarity, some steps leading up to the production of the product effluent comprising hydrogen and a spent catalyst stream comprising catalyst particles and solid carbon as illustrated in FIGS. 1A-2B may be omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

### General Process

The non-limiting illustrative embodiments described herein are directed to a continuous process for catalytic cracking a light hydrocarbon feed stream to produce a product effluent comprising hydrogen and a spent catalyst stream comprising catalyst particles and solid carbon utilizing one or more radial flow moving bed reactors and a heated catalyst solid stream. In one non-limiting illustrative embodiment, the process involves at least flowing a heated catalyst solid stream and fresh catalyst comprising catalyst particles into a radial flow moving bed reactor, wherein the heated catalyst solid stream and fresh catalyst move by gravity through the radial flow moving bed reactor to an exit point of the radial flow moving bed reactor, wherein the heated catalyst solid stream and fresh catalyst form a moving catalyst bed in the radial flow moving bed reactor, and flowing a light hydrocarbon feed stream downwards into the radial flow moving bed reactor in a manner so that the light hydrocarbon feed stream flows radially inward or radially outward through the moving catalyst bed and thereby contacts the heated catalyst solid stream at a temperature sufficient to crack the light hydrocarbon feed stream to produce a product effluent comprising hydrogen and a spent catalyst stream comprising catalyst particles and solid carbon.

In some embodiments, the process further involves combusting, in a riser operatively connected to a bottom portion of the radial flow moving bed reactor, the spent catalyst stream comprising catalyst particles and solid carbon to produce a mixture of another heated catalyst solid stream and a heated gas effluent, separating, in a separator operatively connected to a top portion of the radial flow moving bed reactor and a top portion of the riser, the other heated catalyst solid stream from the heated gas effluent, flowing the other heated catalyst solid stream and additional fresh catalyst downwards into the radial flow moving bed reactor, and flowing a another light hydrocarbon feed stream downwards into the radial flow moving bed reactor in a manner so that the other light hydrocarbon feed stream flows radially inward or radially outward through the moving catalyst bed and thereby contacts the other heated catalyst solid stream at a temperature sufficient to crack the other light hydrocarbon feed stream to produce another product effluent comprising hydrogen and a spent catalyst stream comprising catalyst particles and solid carbon.

The light hydrocarbon feed stream to be employed is not particularly limited and may include, for example, C₁ to C₆ or C₁ to C₄ or C₁ to C₃ or C₁ to C₂ alkanes such as methane, ethane, or natural gas either pure or in any suitable mixture. In some embodiments, the light hydrocarbon feed stream may also contain minor amounts of other ingredients including, for example, carbon dioxide, sulfur compounds such as H₂S, water, nitrogen, and mixtures thereof. In some embodiments the light hydrocarbon feed stream may also include steam, superheated steam, an inert gas such as nitrogen, or any mixture thereof. In some embodiments, the light hydrocarbon feed stream to be employed may include any suitable composition such that the resulting product includes at least hydrogen.

In some embodiments, the light hydrocarbon feed stream comprises methane or natural gas such as, for example, a light hydrocarbon feed stream comprising greater than about 80%, or greater than about 90%, or greater than about 95%, or greater than about 99% methane. As used herein, natural gas comprises methane and potentially higher alkanes, carbon dioxide, nitrogen or other gases, and/or sulfide compounds such as hydrogen sulfide, and mixtures thereof. In illustrative embodiments, the light hydrocarbon feed stream may further contain a portion of the produced products that are recycled back to the light hydrocarbon feed stream along with unreacted methane.

The produced product effluent typically comprises a C₂ to C₁₀ hydrocarbon product and hydrogen. The C₂ to C₁₀ hydrocarbon product is not particularly limited and can be, for example, saturated, unsaturated, aromatic, or a mixture of such compounds. Examples of aromatic hydrocarbons include benzene, toluene, xylene, naphthalene, and methylnaphthalene. In some embodiments the C₂ to C₁₀ hydrocarbon product may comprise ethylene, propylene, acetylene, benzene, naphthalene, and various mixtures thereof depending upon the desired products and reactions used. In addition, as one skilled in the art will readily appreciate, the resulting C₂ to C₁₀ hydrocarbon product can be one of a liquid C₂ to C₁₀ hydrocarbon product or a solid C₂ to C₁₀ hydrocarbon product depending on the particular methane conversion process.

As will be discussed below, the spent catalyst stream including catalyst particles and solid carbon is combusted when in the riser to provide a heated catalyst solid stream such that when flowing into the radial flow moving bed reactor under suitable reaction conditions in the presence of a light hydrocarbon feed stream and fresh catalyst, the heated catalyst solid stream is at a temperature sufficient to crack the light hydrocarbon feed stream to produce hydrogen and a spent catalyst stream comprising catalyst particles and solid carbon. Suitable reaction conditions may vary depending upon the reactants, desired products, catalysts, and equipment employed. In illustrative embodiments, suitable reaction conditions can include a temperature of from about 500° C., or from about 700° C., and up to about 1000° C. or up to about 1200° C., and a pressure of from about 1 atmosphere up to about 3 atmospheres, or up to about 5 atmospheres, or up to about 10 atmospheres may be employed to produce a C₂ to C₁₀ hydrocarbon product and hydrogen.

### Catalyst

In an illustrative embodiment, as may be combined with one or more of the preceding paragraphs, the particulate catalyst for use in the illustrative embodiments described herein can be any cracking catalyst suitable for a radial flow moving bed reactor. In some embodiments, the catalyst can be a supported metal catalyst. Suitable metals include, for example, Ni and Fe, or a mixture thereof. In an illustrative embodiment, the metal can be present in an amount ranging from about 0.01 wt. % to about 10 wt. %. In an illustrative embodiment, a suitable support can be any suitable inorganic oxide support. Representative examples of such suitable oxide supports include, but are not limited to, alumina, silica, silica-alumina, titania, zirconia, or a mixture thereof. In another illustrative embodiment, a suitable support can be a carbon support, such as activated carbon, carbon fiber, carbon nanotube, or a mixture thereof.

The supported metal catalyst may be in any of the commonly used catalyst shapes such as, for example, spheres, granules, pellets, chips, rings, extrudates, or powders that are well-known in the art.

In an illustrative embodiment, as may be combined with one or more of the preceding paragraphs, the particulate catalyst used herein is a small particulate catalyst. The term “small particulate catalyst” as used herein shall be understood to mean a catalyst having an average particle diameter of about 0.05 to about 4 millimeters (mm), or about 0.05 to about 2 mm, or about 0.06 to about 0.5 mm or even around 100 micrometers. Any of the lower limits described above can be combined with any of the upper limits.

### Reactor Systems

The non-limiting illustrative embodiments of the present disclosure, as may be combined with one or more of the preceding paragraphs, will now be further described with reference to the drawings. Referring now to the drawings in more detail, FIGS. 1A-2B illustrate a reactor system including a radial flow moving bed reactor, a riser external to the radial flow moving bed reactor and a separator. It is to be understood that the reactor system including the radial flow moving bed reactor, the riser and the separator is not limited to the configuration of the embodiments shown in FIGS. 1A-2B, and other configurations are contemplated herein. In addition, while the exemplary embodiments are described in FIGS. 1A-2B with a reactor system having one radial flow moving bed reactor, it is to be appreciated that any number of radial flow moving bed reactors arranged in series or parallel are contemplated herein. For example, illustrative embodiments of present disclosure may have 1, 2, 3, 4, 5, 6, or 7 radial flow moving bed reactors arranged in series or parallel.

Referring now to FIGS. 1A and 1B, a reactor system 100 includes a radial flow moving bed reactor 102. Radial flow moving bed reactor 102 can be any radial flow moving bed reactor known in the art. In a non-limiting illustrative embodiment, radial flow moving bed reactor 102 can be a cylindrical reactor vessel having three sections. Each of the three sections are separated by, for example, a wall configured to allow the light hydrocarbon feed stream to enter and make contact with a moving catalyst bed as discussed below such as a screen or ceramic porous wall. In some embodiments, a first section can be a center section 104, a second section can be annular sections 106 and a third section can be outer sections 108. Center section 104 is configured to receive a light hydrocarbon feed stream via line 101. Although only one injection point in the radial flow moving bed reactor is shown for the light hydrocarbon feed stream, it is to be understood that the radial flow moving bed reactor can be designed to have two or more feedstock injection points, namely, at least one for one light hydrocarbon feed stream and at least one for another the light hydrocarbon feed stream.

Annular sections 106 are configured to receive a heated catalyst solid stream and optional fresh catalyst via a line 128 from a separator 124. In operation, the heated catalyst solid stream and optional fresh catalyst enter and move vertically downward through annular sections 106 as a moving catalyst bed, while the light hydrocarbon feed stream flows radially outward from center section 104 into annular sections 106 through a wall configured to allow the light hydrocarbon feed stream to enter and make contact with the moving catalyst bed. In this way, the light hydrocarbon feed stream flows perpendicularly or substantially perpendicularly to the movement of the heated catalyst solid stream and optional fresh catalyst in radial flow moving bed reactor 102. As a result of the light hydrocarbon feed streams contacting the moving catalyst bed containing the heated catalyst solid stream and optional fresh catalyst in annular sections 106 under reaction conditions discussed above sufficient to crack the light hydrocarbons in the light hydrocarbon feed streams, a product effluent comprising hydrogen is formed as well as a solid carbon byproduct that deposits on the catalyst particles.

In some embodiments, the heated catalyst solid stream will be heated to a desired temperature to carry the thermal energy necessary for the endothermic reactions of the light hydrocarbon feed stream that take place inside the moving catalyst bed. This, in turn, allows for radial flow moving bed reactor 102 to be operated adiabatically, i.e., no additional heat is provided to radial flow moving bed reactor 102.

The gravity flow of the heated catalyst solid stream and optional fresh catalyst from an upper portion of radial flow moving bed reactor 102 to a lower portion of radial flow moving bed reactor 102 through the moving catalyst bed in annular sections 106 and the radial flow of the light hydrocarbon feed stream involve flowing the light hydrocarbon feed stream into radial flow moving bed reactor 102 in a manner such that the light hydrocarbon feed stream flows radially outward from center section 104 and through the moving catalyst bed in annular sections 106 thereby contacting the moving catalyst bed under reaction conditions to produce hydrogen and solid carbon by-product that deposits on the catalyst particles. The moving catalyst bed, according to illustrative embodiments of the present disclosure, has the heated catalyst solid stream and optional fresh catalyst moving slowly. In this way, the moving catalyst bed implemented herein can provide high production capacity without increased pressure drop or increased vessel size while the heated catalyst solid stream and optional fresh catalyst remain at an acceptable activity level, by continuous catalyst renewal.

In an illustrative embodiment, the pressure drop across radial flow moving bed reactor 102, velocity of the heated catalyst solid stream and optional fresh catalyst in the moving catalyst bed and reaction times inside radial flow moving bed reactor 102 can be as discussed below.

In some embodiments as depicted in FIG. 1B, radial flow moving bed reactor 102 can further include a heating unit 130 embedded in the moving catalyst bed within annular sections 106. Heating unit 130 can be used to maintain the entire moving catalyst bed at a sufficient temperature to crack the light hydrocarbon feed stream and produce a product effluent comprising hydrogen and the spent catalyst stream comprising catalyst particles and solid carbon. Heating unit 130 can be any suitable heating unit for maintaining the entire moving catalyst bed at a sufficient temperature to crack the light hydrocarbon feed stream. In some embodiments, heating unit 130 can be an electric heater with one or more horizontally or vertically oriented heating elements distributed across the cross-section of annular sections 106 utilizing, for example, electricity. The electricity used for heating unit 130 can be by use of renewable electricity (e.g., solar, wind, hydroelectric, geothermal, or the like electricity) when available, or by electricity from a grid. It is particularly useful to use renewable electricity such that relatively little to no carbon dioxide is generated during the processing of the light hydrocarbon feed stream.

In some embodiments, heating unit 130 can include one or more heating elements for receiving heated or super-heated gases from, for example, a fired furnace. In some embodiments, heating unit 130 can include one or more heating elements heated internally by combustion or other exothermic chemical reactions. In some embodiments, heating unit 130 can include one or more heating tubes that are semi-porous tubes heated by reaction of a reactant gas with oxygen on or near the surface of the heating tubes. In some embodiments, heating unit 130 can include a heat exchanger configured to heat the light hydrocarbon feed stream using heat extracted from a high-temperature fluid, such as a fluid heated to about 1200° C. or more, or by burning hydrogen produced during the processing of the light hydrocarbon feed stream. In some embodiments, a heat exchanger may be a shell-and-tube, plate-fin, microchannel, spiral wound, or any other suitable heat exchanger.

In some embodiments, a suitable wall to separate center section 104 and annular sections 106 includes, for example, a screen, a perforated plate, a porous wall, or any other type of wall that has a porosity to allow gas flow through it but not any solid catalysts. In a further embodiment, the wall can consist of a Johnson screen. In some embodiments, center section 104 extends from the top to the bottom of radial flow moving bed reactor 102. In some embodiments, center section 104 only extends from a top surface of radial flow moving bed reactor 102 to a lower section of radial flow moving bed reactor 102, e.g., occupying from about 30% to about 90%, or from about 50% to about 70% of the entire height of radial flow moving bed reactor 102. In some embodiments, annular sections 106 and outer sections 108 are of a height H1 and center section 104 is of a height H2 less than height H1.

In some embodiments, a suitable wall separating outer sections 108 and annular sections 106 includes, for example, a screen, a perforated plate, a porous wall, or any other type of wall that allows gas flow through but not solid catalysts. In a further embodiment, the wall can consist of a Johnson screen. In some embodiments, the wall consists of a membrane with a high selectivity to hydrogen, hence allowing continuous removal of hydrogen from the reactant stream to effectively increase the conversion of the light hydrocarbon feed stream to hydrogen and solid carbon.

Outer sections 108 are configured to receive the product effluent produced in annular sections 106 through the walls separating annular sections 106 and outer sections 108. The product effluent thereafter exits radial flow moving bed reactor 102 via a line 110, i.e., a C₂ to C₁₀ hydrocarbon product and hydrogen, that is then sent downstream for further processing.

In some embodiments, a portion of the spent catalyst stream can be withdrawn from a bottom portion of radial flow moving bed reactor 102 through a line 112 and another portion of the spent catalyst stream can be withdrawn from a bottom portion of radial flow moving bed reactor 102 and sent to a riser 120 through a catalyst transfer line 114. For example, during cracking of the light hydrocarbon feed stream in the presence of the heated catalyst solid stream, the particle size of the fresh catalyst will change significantly from fresh catalyst to spent catalyst when the solid carbon coproduced during the cracking deposits on the catalyst, e.g., the light hydrocarbon feed stream such as methane cracks on nanoparticles to grow solid carbon nanotubes thereby changing the particle size. For example, a distribution of particles of the fresh catalyst will have a first particle size and a distribution of particles of the spent catalyst stream will be a second particle size greater than the first particle size. This, in turn, provides a varying particle size distribution of the spent catalyst stream. Accordingly, the larger particles will settle to the bottom portion of radial flow moving bed reactor 102 where they may be commutated or settle out and transferred to riser 120 by pneumatic transport via catalyst transfer line 114. The inventory of the spent catalyst stream to riser 120 is controlled by the level of catalyst in radial flow moving bed reactor 102. Thus, depending on the inventory of the spent catalyst stream in the bottom portion of radial flow moving bed reactor 102, a portion of the spent catalyst stream can be withdrawn from the bottom portion of radial flow moving bed reactor 102 through line 112. In one embodiment, line 112 is an unobstructed outlet at the bottom portion of radial flow moving bed reactor 102 to prevent fouling and plugging of radial flow moving bed reactor 102. In some embodiments, another portion of the spent catalyst stream is sent to riser 120 via catalyst transfer line 114. The spent catalyst stream flows downward in radial flow moving bed reactor 102 by, for example, gravity forces.

In one embodiment, the offtake of the spent catalyst stream withdrawn from the bottom portion of radial flow moving bed reactor 102 through line 112 can be loop sealed or sent in a separate vessel. In some embodiments, the spent catalyst stream withdrawn from the bottom portion of radial flow moving bed reactor 102 through line 112 can be further used to pre-heat the light hydrocarbon feed stream.

Radial flow moving bed reactor 102 further includes riser 120 for receiving the spent catalyst stream comprising catalyst particles and solid carbon via catalyst transfer line 114 which is in fluid communication with radial flow moving bed reactor 102 and riser 120. In one embodiment, loop seals are required in catalyst transfer line 114 to separate any highly flammable hydrocarbon gases present in radial flow moving bed reactor 102 from any oxidizing gas present in riser 120. In some embodiments, steam can also be injected in catalyst transfer line 114 to keep the transfer line fluidized. The steam pressure is sufficient to act as a gas barrier between radial flow moving bed reactor 102 and riser 120 to prevent or inhibit any mixing of the oxidizing gas and hydrocarbon gases.

In an illustrative embodiment, riser 120 includes a gas inlet adapted to receive an oxidizing gas stream into riser 120 via a line 116. The gas inlet may be disposed at the bottom of riser 120. However, this is merely illustrative and other locations for the gas inlet are contemplated herein. As discussed below, solid carbon is formed on the surface of the spent catalyst stream comprising the catalyst particles and solid carbon, i.e., solid carbon-catalyst particles. At least a portion of the solid carbon can be burned from the spent catalyst stream by exposing the spent catalyst stream to the oxidizing gas stream, e.g., an inert gas/air such as air, oxygen, nitrogen, methane, or combinations thereof or a steam/air mixture, at appropriate high temperature and time duration conditions to burn off at least a portion of the solid carbon, if not all, from the catalyst particles. A heated catalyst solid stream is thereby produced including heated catalyst particles. In some embodiments, the heated catalyst solid stream will be heated to a desired temperature to carry the thermal energy necessary for the endothermic reactions of the light hydrocarbon feed stream that take place inside annular sections 106 in radial flow moving bed reactor 102. In an illustrative embodiment, a temperature can range from about 450° C. to about 1500° C. or from about 600° C. to about 1500° C. or from about 450° C. to about 1400° C., and a time period can range from about 10 minutes to about 600 minutes.

In some embodiments, the oxidizing gas stream combusts with the spent catalyst where a portion of the solid carbon is burnt to regenerate the spent catalyst while producing the heated catalyst solid stream. Accordingly, regenerating the spent catalyst generally comprises combustion of the spent catalyst in an oxidizing atmosphere to burn at least a portion of the solid carbon and redisperse active metal on the catalyst particles. Burning the solid carbon is an exothermic process that can supply the heat needed for the reaction process. In a heat balanced operation, the quantity of solid carbon formed on the catalyst is significant enough that no external heat source or fuel is needed to supplement the heat from combustion.

The solid carbon burn causes the spent catalyst to be heated to an elevated temperature, e.g., a temperature of about 450° C. to about 1500° C., to provide a mixture of the heated catalyst solid stream, wherein the catalyst particles are heated, and heated gas effluent 118. In some embodiments the heated gas effluent is regenerator flue gas composed of, for example, carbon dioxide and nitrogen.

The heat generated by the solid carbon burn in riser 120 is also continuously transferred with the mixture of the heated catalyst solid stream and the heated gas effluent 118 which flows upwards and is continuously passed out of riser 120 into separator 124.

In an illustrative embodiment, a top portion of riser 120 is operatively connected to a top portion of separator 124 and a bottom portion of riser 120 is operatively connected to a bottom portion of radial flow moving bed reactor 102 via catalyst transfer line 114. In some embodiments, riser 120 is essentially a pipe with a suitable diameter to allow both gas and solids to flow upwardly in a pneumatic transferring regime, i.e., the spent catalyst stream comprising catalyst particles and solid carbon can be introduced to riser 120 in the presence of the oxidizing gas stream at the bottom of riser 120 in which the gas flow is sufficiently high to pneumatically transport the mixture of the heated catalyst solid stream and the heated gas effluent 118 into separator 124. In some embodiments, riser 120 is a vessel with top and bottom sections of different diameters.

Separator 124 is located in a top portion of radial flow moving bed reactor 102. In some embodiments, separator 124 extends beyond a top surface of the top portion of radial flow moving bed reactor 102 and is external to radial flow moving bed reactor 102. In some embodiments, separator 124 includes a first portion located internally in radial flow moving bed reactor 102 and a second portion located externally from radial flow moving bed reactor 102 and extending above a top surface of the top portion of radial flow moving bed reactor 102 and operatively connected to the top portion of riser 120. Separator 124 receives the mixture of the heated catalyst solid stream and the heated gas effluent 118 from riser 120 and then separates the heated gas effluent from the heated catalyst solid stream to generate a product gas effluent which then exits separator 124 via a line 126 for further processing. In some embodiments, a suitable separator for use herein as separator 124 includes, for example, a cyclone. Although one separator is shown for separator 124, the number of separators is merely illustrative and any number can be used in radial flow moving bed reactor 102 based on such factors as, for example, reactor design, etc. In some embodiments, the separators are external with a refractory liner to allow for higher temperature operations in both radial flow moving bed reactor 102 and riser 120.

Suitable materials for use as the refractory liner are those that provide good thermal insulation and abrasion resistance. In some embodiments, the reactor lining is castable. A wide variety of suitable refractory materials are known including, for example, standard Portland cement. As one skilled in the art will appreciate, the refractory materials can be inorganic, nonmetallic, porous and heterogeneous materials comprising thermally stable mineral aggregates, a binder phase and one or more additives. In some embodiments, the refractory material may comprise one or more of silica, alumina, calcium oxide, titanium oxide, iron oxide, magnesium oxide, zirconium and others. Different compositions can be selected for different applications, with design considerations including degree of thermal and abrasion resistance needed. Examples include higher abrasion resistant refractory materials in sections of the lining that may be subject to significant abrasion. In another embodiment, the refractory lining may consist of more than one layer. For example, in some embodiments, a top layer can include a high abrasion resistant refractory material and one or more multiple layers underneath can include lower thermal conductive materials having a thickness greater than the thickness of the top layer. As one skilled in the art will readily appreciate, different refractory materials and thicknesses may apply at different locations based on the temperature, turbulence intensity, erosion tendency, etc.

The heated catalyst solid stream then flows downward from separator 124 into the top portion of radial flow moving bed reactor 102 via line 128. In some embodiments, it may be necessary to add fresh catalyst to assist with the cracking of the light hydrocarbon feed stream. Thus, in some embodiments, fresh catalyst can be introduced into the top portion of radial flow moving bed reactor 102 (not shown) or into riser 120 via a line 122 to be combined with the mixture of the heated catalyst solid stream and the heated gas effluent 118.

In illustrative embodiments, the light hydrocarbon feed stream and the heated catalyst solid stream are subjected to reaction conditions such as, for example, a temperature of from about 500° C. to about 1200° C., a pressure drop across the radial flow moving bed reactor of from about 1 to about 10 psi, or from about 1 to about 3 psi, and for a residence time of the light hydrocarbon feed stream in radial flow moving bed reactor 102 of from about 0.05 seconds to about 100 seconds, or from about 0.1 seconds to about 2 seconds. In some embodiments, a velocity of the heated catalyst solid stream in radial flow moving bed reactor 102 can be less than about 1 m/s, or less than about 0.5 m/s, e.g., from about 0.001 m/s to about 1 m/s, or to about 0.5 m/s.

Referring now to the FIGS. 2A-2B, a non-limiting illustrative embodiment of a radial flow moving bed reactor 202 as an inward flowing radial flow moving bed reactor for use in a reactor system 200 for converting a light hydrocarbon feed stream to hydrogen and generating a spent catalyst stream comprising catalyst particles and solid carbon will now be described.

Reactor system 200 includes radial flow moving bed reactor 202. Radial flow moving bed reactor 202 can be any radial flow moving bed reactor as discussed above for radial flow moving bed reactor 102. For example, radial flow moving bed reactor 202 can be a cylindrical reactor vessel having three sections. Each of the three sections are separated by, for example, a wall configured to allow the light hydrocarbon feed stream to enter and make contact with a moving catalyst bed as discussed above. In some embodiments, a first section can be a center section 204, a second section can be annular sections 206 and a third section can be outer sections 208. Outer sections 208 are configured to receive a light hydrocarbon feed stream via a line 201. Although only one injection point in the radial flow moving bed reactor is shown for the light hydrocarbon feed stream, it is to be understood that the radial flow moving bed reactor can be designed to have two or more feedstock injection points, namely, at least one for one light hydrocarbon feed stream and at least one for another light hydrocarbon feed stream.

Annular sections 206 are configured to receive a heated catalyst solid stream and optional fresh catalyst via a line 228 from a separator 224. In operation, the heated catalyst solid stream and optional fresh catalyst enter and move vertically downward through annular sections 206 as a moving catalyst bed, while the light hydrocarbon feed stream flows radially inward from outer sections 208 into annular sections 206 through a wall configured to allow the light hydrocarbon feed stream to enter and make contact with the moving catalyst bed. In this way, the light hydrocarbon feed stream flows perpendicularly or substantially perpendicularly to the movement of the heated catalyst solid stream and optional fresh catalyst in radial flow moving bed reactor 202. As a result of the light hydrocarbon feed streams contacting the moving catalyst bed containing the heated catalyst solid stream and optional fresh catalyst in annular sections 206 under reaction conditions discussed above sufficient to crack the light hydrocarbons in the light hydrocarbon feed streams, a product effluent comprising hydrogen is formed as well as a solid carbon byproduct that deposits on the catalyst particles.

In some embodiments, the heated catalyst solid stream will be heated to a desired temperature to carry the thermal energy necessary for the endothermic reactions of the light hydrocarbon feed stream that take place inside the moving catalyst bed. This, in turn, allows for radial flow moving bed reactor 202 to be operated adiabatically, i.e., no additional heat is provided to radial flow moving bed reactor 202.

The gravity flow of the heated catalyst solid stream and optional fresh catalyst from an upper portion of radial flow moving bed reactor 202 to a lower portion of radial flow moving bed reactor 202 through the moving catalyst bed in annular sections 206 and the radial flow of the light hydrocarbon feed stream involve flowing the light hydrocarbon feed stream into radial flow moving bed reactor 202 in a manner such that the light hydrocarbon feed stream flows radially inward from outer sections 208 and through the moving catalyst bed in annular sections 206 thereby contacting the moving catalyst bed under reaction conditions to produce hydrogen and solid carbon by-product that deposits on the catalyst particles. The moving catalyst bed, according to illustrative embodiments of the present disclosure, has the heated catalyst solid stream and optional fresh catalyst moving slowly. In this way, the moving catalyst bed implemented herein can provide high production capacity without increased pressure drop or increased vessel size while the heated catalyst solid stream and optional fresh catalyst remain at an acceptable activity level, by continuous catalyst renewal.

In an illustrative embodiment, the pressure drop across radial flow moving bed reactor 202, velocity of the heated catalyst solid stream and optional fresh catalyst in the moving catalyst bed and reaction times inside radial flow moving bed reactor 202 can be as discussed above.

In some embodiments as depicted in FIG. 2B, radial flow moving bed reactor 202 can further include a heating unit 230 embedded in the moving catalyst bed within annular sections 206. Heating unit 230 can be used to maintain the entire moving catalyst bed at a sufficient temperature to crack the light hydrocarbon feed stream and produce a product effluent comprising hydrogen and the spent catalyst stream comprising catalyst particles and solid carbon. Heating unit 230 can be any suitable heating unit as discussed above for heating unit 130.

In some embodiments, a suitable wall to separate annular sections 206 and outer sections 208 includes, for example, a screen, a perforated plate, a porous wall, or any other type of wall that has a porosity to allow gas flow through it but not any solid catalysts. In a further embodiment, the wall can consist of a Johnson screen. In some embodiments, annular sections 206 extend from the top to the bottom of radial flow moving bed reactor 202. In some embodiments, outer sections 208 only extend from a top surface of radial flow moving bed reactor 202 to a lower section of radial flow moving bed reactor 202, e.g., occupying from about 30% to about 90%, or from about 50% to about 70% of the entire height of radial flow moving bed reactor 202. In some embodiments, center section 204 and annular sections 206 are of a height H1 and outer sections 208 are of a height H2 less than height H1.

In some embodiments, a suitable wall separating center section 204 and annular sections 206 includes, for example, a screen, a perforated plate, a porous wall, or any other type of wall that allows gas flow through but not solid catalysts. In a further embodiment, the wall can consist of a Johnson screen. In some embodiments, the wall consists of a membrane with a high selectivity to hydrogen, hence allowing continuous removal of hydrogen from the reactant stream to effectively increase the conversion of the light hydrocarbon feed stream to hydrogen and solid carbon.

Center section 204 is configured to receive the product effluent produced in annular sections 206 through the walls separating annular sections 206 from center section 204. The product effluent thereafter exits radial flow moving bed reactor 202 via a line 210, i.e., a C₂ to C₁₀ hydrocarbon product and hydrogen, that is then sent downstream for further processing.

In some embodiments, a portion of the spent catalyst stream can be withdrawn from a bottom portion of radial flow moving bed reactor 202 through a line 212 and another portion of the spent catalyst stream can be withdrawn from a bottom portion of radial flow moving bed reactor 202 and sent to a riser 220 through a catalyst transfer line 214 as discussed above with reference to FIGS. 1A and 1B. In some embodiments, another portion of the spent catalyst stream is sent to riser 220 via catalyst transfer line 214. The spent catalyst stream flows downward in radial flow moving bed reactor 202 by, for example, gravity forces.

In one embodiment, the offtake of the spent catalyst stream withdrawn from the bottom portion of radial flow moving bed reactor 202 through line 212 can be loop sealed or sent in a separate vessel. In some embodiments, the spent catalyst stream withdrawn from the bottom portion of radial flow moving bed reactor 202 through line 212 can be further used to pre-heat the light hydrocarbon feed stream.

Radial flow moving bed reactor 202 further includes riser 220 for receiving the spent catalyst stream comprising catalyst particles and solid carbon via catalyst transfer line 214 which is in fluid communication with radial flow moving bed reactor 202 and riser 220. In one embodiment, loop seals are required in catalyst transfer line 214 to separate any highly flammable hydrocarbon gases present in radial flow moving bed reactor 202 from any oxidizing gas present in riser 220. In some embodiments, steam can also be injected in catalyst transfer line 214 to keep the transfer line fluidized. The steam pressure is sufficient to act as a gas barrier between radial flow moving bed reactor 202 and riser 220 to prevent or inhibit any mixing of the oxidizing gas and hydrocarbon gases.

In an illustrative embodiment, riser 220 includes a gas inlet adapted to receive an oxidizing gas stream into riser 220 via a line 216. The gas inlet may be disposed at the bottom of riser 220. However, this is merely illustrative and other locations for the gas inlet are contemplated herein. As discussed above, solid carbon is formed on the surface of the spent catalyst stream comprising the catalyst particles and solid carbon, i.e., solid carbon-catalyst particles. At least a portion of the solid carbon can be burned from the spent catalyst stream by exposing the spent catalyst stream to the oxidizing gas stream, e.g., an inert gas/air such as air, oxygen, nitrogen, methane, or combinations thereof or a steam/air mixture, at appropriate high temperature and time duration conditions to burn off at least a portion of the solid carbon, if not all, from the catalyst particles. A heated catalyst solid stream is thereby produced including heated catalyst particles. In some embodiments, the heated catalyst solid stream will be heated to a desired temperature to carry the thermal energy necessary for the endothermic reactions of the light hydrocarbon feed stream that take place inside annular sections 206 in radial flow moving bed reactor 202. In an illustrative embodiment, a temperature can range from about 450° C. to about 1500° C. or from about 600° C. to about 1500° C. or from about 450° C. to about 1400° C., and a time period can range from about 10 minutes to about 600 minutes.

In some embodiments, the oxidizing gas stream combusts with the spent catalyst where a portion of the solid carbon is burnt to regenerate the spent catalyst while producing the heated catalyst solid stream. Accordingly, regenerating the spent catalyst generally comprises combustion of the spent catalyst in an oxidizing atmosphere to burn at least a portion of the solid carbon and redisperse active metal on the catalyst particles. Burning the solid carbon is an exothermic process that can supply the heat needed for the reaction process. In a heat balanced operation, the quantity of solid carbon formed on the catalyst is significant enough that no external heat source or fuel is needed to supplement the heat from combustion.

The solid carbon burn causes the spent catalyst to be heated to an elevated temperature, e.g., a temperature of from about 450° C. to about 1500° C., to provide a mixture of the heated catalyst solid stream, wherein the catalyst particles are heated, and heated gas effluent 218. In some embodiments the heated gas effluent is regenerator flue gas composed of, for example, carbon dioxide and nitrogen.

The heat generated by the solid carbon burn in riser 220 is also continuously transferred with the mixture of the heated catalyst solid stream and the heated gas effluent 218 which flows upwards and is continuously passed out of riser 220 into separator 224.

In an illustrative embodiment, a top portion of riser 220 is operatively connected to a top portion of separator 224 and a bottom portion of riser 220 is operatively connected to a bottom portion of radial flow moving bed reactor 202 via catalyst transfer line 214. In some embodiments, riser 220 is as described above for riser 120.

Separator 224 is located in a top portion of radial flow moving bed reactor 202. In some embodiments, separator 224 extends beyond a top surface of the top portion of radial flow moving bed reactor 202 and is external to radial flow moving bed reactor 202. In some embodiments, separator 224 includes a first portion located internally in radial flow moving bed reactor 202 and a second portion located externally from radial flow moving bed reactor 202 and extending above a top surface of the top portion of radial flow moving bed reactor 202 and operatively connected to the top portion of riser 220. Separator 224 receives the mixture of the heated catalyst solid stream and the heated gas effluent 218 from riser 220 and then separates the heated gas effluent from the heated catalyst solid stream to generate a product gas effluent which then exits separator 224 via a line 226 for further processing. In some embodiments, a suitable separator for use herein as separator 224 includes, for example, a cyclone. Although one separator is shown for separator 224, the number of separators is merely illustrative and any number can be used in radial flow moving bed reactor 202 based on such factors as, for example, reactor design, etc. In some embodiments, the separators are external with a refractory liner as discussed above to allow for higher temperature operations in both radial flow moving bed reactor 202 and riser 220.

The heated catalyst solid stream then flows downward from separator 224 into the top portion of radial flow moving bed reactor 202 via line 228. In some embodiments, it may be necessary to add fresh catalyst to assist with the cracking of the light hydrocarbon feed stream. Thus, in some embodiments, fresh catalyst can be introduced into the top portion of radial flow moving bed reactor 202 (not shown) or into riser 220 via a line 222 to be combined with the mixture of the heated catalyst solid stream and the heated gas effluent 218.

In illustrative embodiments, the light hydrocarbon feed stream and the heated catalyst solid stream are subjected to reaction conditions such as, for example, a temperature of from about 500° C. to about 1200° C., a pressure drop across the radial flow moving bed reactor of from about 1 to about 10 psi, or from about 1 to about 3 psi, and for a residence time of the light hydrocarbon feed stream in radial flow moving bed reactor 202 of from about 0.05 seconds to about 100 seconds, or from about 0.1 seconds to about 2 seconds. In some embodiments, a velocity of the heated catalyst solid stream in radial flow moving bed reactor 102 can be less than about 1 m/s, or less than about 0.5 m/s, e.g., from about 0.001 m/s to about 1 m/s, or to about 0.5 m/s.

According to an aspect of the present disclosure, a radial flow moving bed reactor system comprises:
a radial flow moving bed reactor configured to flow a first heated catalyst solid stream and fresh catalyst comprising catalyst particles by gravity through the radial flow moving bed reactor to an exit point of the radial flow moving bed reactor, wherein the first heated catalyst solid stream and the fresh catalyst form a moving catalyst bed in the radial flow moving bed reactor, wherein the radial flow moving bed reactor is further configured to flow a light hydrocarbon feed stream downwards in a manner so that the light hydrocarbon feed stream flows radially inward or radially outward through the moving catalyst bed and thereby contacts the first heated catalyst solid stream at a temperature sufficient to crack the light hydrocarbon feed stream to produce a product effluent comprising hydrogen and a spent catalyst stream comprising catalyst particles and solid carbon,
a riser operatively connected to a bottom portion of the radial flow moving bed reactor, the riser being configured to combust the spent catalyst stream comprising catalyst particles and solid carbon to produce a mixture of a second heated catalyst solid stream and a heated gas effluent, and
a separator operatively connected to a top portion of the radial flow moving bed reactor and a top portion of the riser, the separator being configured to separate the second heated catalyst solid stream from the heated gas effluent.

In one or more additional illustrative embodiments, as may be combined with the preceding paragraphs, the separator comprises a first portion located internally in the radial flow moving bed reactor and a second portion located externally from the radial flow moving bed reactor and operatively connected to the top portion of the riser.

In one or more additional illustrative embodiments, as may be combined with the preceding paragraphs, the radial flow moving bed reactor comprises a center section, outer sections and an annular section located between the center section and each outer section.

In one or more additional illustrative embodiments, as may be combined with the preceding paragraphs, the first heated catalyst solid stream and the fresh catalyst form the moving catalyst bed in the annular section, the light hydrocarbon feed stream flows downward into the center section and radially outward into the annular section, and the product effluent comprising hydrogen and the spent catalyst stream comprising catalyst particles and solid carbon flows from the annular section into the outer sections to an exit point in the radial flow moving bed reactor.

In one or more additional illustrative embodiments, as may be combined with the preceding paragraphs, the outer sections and the annular section have a first height and the center section has a second height less than the first height.

In one or more additional illustrative embodiments, as may be combined with the preceding paragraphs, the first heated catalyst solid stream and the fresh catalyst form the moving catalyst bed in the annular section, the light hydrocarbon feed stream flows downward into the outer sections and radially inward into the annular section, and the product effluent comprising hydrogen and the spent catalyst stream comprising catalyst particles and solid carbon flows from the annular section into the center section to an exit point in the radial flow moving bed reactor.

In one or more additional illustrative embodiments, as may be combined with the preceding paragraphs, the center section and the annular section have a first height and the outer sections have a second height less than the first height.

In one or more additional illustrative embodiments, as may be combined with the preceding paragraphs, the radial flow moving bed reactor system further comprises a heating unit located internally in the radial flow moving bed reactor, the heating unit configured to maintain a temperature of the moving catalyst bed at the temperature sufficient to crack the light hydrocarbon feed stream to produce the product effluent comprising hydrogen and the spent catalyst stream comprising catalyst particles and solid carbon.

In one or more additional illustrative embodiments, as may be combined with the preceding paragraphs, the heating unit comprises an electric heater.

In one or more additional illustrative embodiments, as may be combined with the preceding paragraphs, the first heated catalyst solid stream and the second heated catalyst solid stream each individually have a temperature of from about 450° C. to about 1500° C., and the light hydrocarbon feed stream is a natural gas stream.

According to another aspect of the present disclosure, a continuous process comprises:
flowing a heated catalyst solid stream and fresh catalyst comprising catalyst particles into a radial flow moving bed reactor, wherein the heated catalyst solid stream and fresh catalyst move by gravity through the radial flow moving bed reactor to an exit point of the radial flow moving bed reactor, wherein the heated catalyst solid stream and fresh catalyst form a moving catalyst bed in the radial flow moving bed reactor, and
flowing a light hydrocarbon feed stream downwards into the radial flow moving bed reactor in a manner so that the light hydrocarbon feed stream flows radially inward or radially outward through the moving catalyst bed and thereby contacts the heated catalyst solid stream at a temperature sufficient to crack the light hydrocarbon feed stream to produce a product effluent comprising hydrogen and a spent catalyst stream comprising catalyst particles and solid carbon.

In one or more additional illustrative embodiments, as may be combined with the preceding paragraphs, the continuous process further comprises:
receiving, in a riser operatively connected to a bottom portion of the radial flow moving bed reactor, the spent catalyst stream comprising catalyst particles and solid carbon;
combusting, in the riser, the spent catalyst stream to produce a mixture of another heated catalyst solid stream and a heated gas effluent, and
separating, in a separator operatively connected to a top portion of the radial flow moving bed reactor and a top portion of the riser, the other heated catalyst solid stream from the heated gas effluent.

In one or more additional illustrative embodiments, as may be combined with the preceding paragraphs, the combusting the spent catalyst stream comprising catalyst particles and solid carbon comprises contacting the spent catalyst stream with an oxidizing gas stream.

In one or more additional illustrative embodiments, as may be combined with the preceding paragraphs, the oxidizing gas stream comprises one of an inert gas, air, mixtures thereof or a steam and air mixture.

In one or more additional illustrative embodiments, as may be combined with the preceding paragraphs, the radial flow moving bed reactor comprises a center section, outer sections and an annular section located between the center section and each outer section, and the process comprises flowing the heated catalyst solid stream and the fresh catalyst into the annular section to form the moving catalyst bed; flowing the light hydrocarbon feed stream downward into the center section and radially outward into the annular section; and flowing the product effluent comprising hydrogen and the spent catalyst stream comprising catalyst particles and solid carbon flows from the annular section into the outer sections to an exit point in the radial flow moving bed reactor.

In one or more additional illustrative embodiments, as may be combined with the preceding paragraphs, the outer sections and the annular section have a first height and the center section has a second height less than the first height.

In one or more additional illustrative embodiments, as may be combined with the preceding paragraphs, the radial flow moving bed reactor comprises a center section, outer sections and an annular section located between the center section and each outer section, and the process comprises flowing the heated catalyst solid stream and the fresh catalyst into the annular section to form the moving catalyst bed; flowing the light hydrocarbon feed stream downward into the outer sections and radially inward into the annular section; and flowing the product effluent comprising hydrogen and the spent catalyst stream comprising catalyst particles and solid carbon flows from the annular section into the center section to an exit point in the radial flow moving bed reactor.

In one or more additional illustrative embodiments, as may be combined with the preceding paragraphs, the center section and the annular section have a first height and the outer sections have a second height less than the first height.

In one or more additional illustrative embodiments, as may be combined with the preceding paragraphs, the continuous process further comprises heating the moving catalyst bed to maintain a temperature of the moving catalyst bed at the temperature sufficient to crack the light hydrocarbon feed stream to produce the product effluent comprising hydrogen and the spent catalyst stream comprising catalyst particles and solid carbon using a heating unit located internally in the radial flow moving bed reactor.

In one or more additional illustrative embodiments, as may be combined with the preceding paragraphs, the heated catalyst solid stream has a temperature of from about 450° C. to about 1500° C., and the light hydrocarbon feed stream is a natural gas stream.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A radial flow moving bed reactor system, comprising:
a radial flow moving bed reactor configured to flow a first heated catalyst solid stream and fresh catalyst comprising catalyst particles by gravity through the radial flow moving bed reactor to an exit point of the radial flow moving bed reactor, wherein the first heated catalyst solid stream and the fresh catalyst form a moving catalyst bed in the radial flow moving bed reactor, wherein the radial flow moving bed reactor is further configured to flow a light hydrocarbon feed stream downwards in a manner so that the light hydrocarbon feed stream flows radially inward or radially outward through the moving catalyst bed and thereby contacts the first heated catalyst solid stream at a temperature sufficient to crack the light hydrocarbon feed stream to produce a product effluent comprising hydrogen and a spent catalyst stream comprising catalyst particles and solid carbon;
a riser operatively connected to a bottom portion of the radial flow moving bed reactor, the riser being configured to combust the spent catalyst stream comprising catalyst particles and solid carbon to produce a mixture of a second heated catalyst solid stream and a heated gas effluent; and
a separator operatively connected to a top portion of the radial flow moving bed reactor and a top portion of the riser, the separator being configured to separate the second heated catalyst solid stream from the heated gas effluent.

2. The radial flow moving bed reactor system according to claim 1, wherein the separator comprises a first portion located internally in the radial flow moving bed reactor and a second portion located externally from the radial flow moving bed reactor and operatively connected to the top portion of the riser.

3. The radial flow moving bed reactor system according to claim 1, wherein the radial flow moving bed reactor comprises a center section, outer sections and an annular section located between the center section and each outer section.

4. The radial flow moving bed reactor system according to claim 3, wherein the first heated catalyst solid stream and the fresh catalyst form the moving catalyst bed in the annular section, the light hydrocarbon feed stream flows downward into the center section and radially outward into the annular section, and the product effluent comprising hydrogen and the spent catalyst stream comprising catalyst particles and solid carbon flows from the annular section into the outer sections to an exit point in the radial flow moving bed reactor.

5. The radial flow moving bed reactor system according to claim 4, wherein the outer sections and the annular section have a first height and the center section has a second height less than the first height.

6. The radial flow moving bed reactor system according to claim 3, wherein the first heated catalyst solid stream and the fresh catalyst form the moving catalyst bed in the annular section, the light hydrocarbon feed stream flows downward into the outer sections and radially inward into the annular section, and the product effluent comprising hydrogen and the spent catalyst stream comprising catalyst particles and solid carbon flows from the annular section into the center section to an exit point in the radial flow moving bed reactor.

7. The radial flow moving bed reactor system according to claim 6, wherein the center section and the annular section have a first height and the outer sections have a second height less than the first height.

8. The radial flow moving bed reactor system according to claim 1, further comprising a heating unit located internally in the radial flow moving bed reactor, the heating unit configured to maintain a temperature of the moving catalyst bed at the temperature sufficient to crack the light hydrocarbon feed stream to produce the product effluent comprising hydrogen and the spent catalyst stream comprising catalyst particles and solid carbon.

9. The radial flow moving bed reactor system according to claim 8, wherein the heating unit comprises an electric heater.

10. The radial flow moving bed reactor system according to claim 1, wherein the first heated catalyst solid stream and the second heated catalyst solid stream each individually have a temperature of from about 450° C. to about 1500° C., and the light hydrocarbon feed stream is a natural gas stream.

11. A continuous process, comprising:
flowing a heated catalyst solid stream and fresh catalyst comprising catalyst particles into a radial flow moving bed reactor, wherein the heated catalyst solid stream and fresh catalyst move by gravity through the radial flow moving bed reactor to an exit point of the radial flow moving bed reactor, wherein the heated catalyst solid stream and fresh catalyst form a moving catalyst bed in the radial flow moving bed reactor; and
flowing a light hydrocarbon feed stream downwards into the radial flow moving bed reactor in a manner so that the light hydrocarbon feed stream flows radially inward or radially outward through the moving catalyst bed and thereby contacts the heated catalyst solid stream at a temperature sufficient to crack the light hydrocarbon feed stream to produce a product effluent comprising hydrogen and a spent catalyst stream comprising catalyst particles and solid carbon.

12. The continuous process according to claim 11, further comprising:
receiving, in a riser operatively connected to a bottom portion of the radial flow moving bed reactor, the spent catalyst stream comprising catalyst particles and solid carbon;
combusting, in the riser, the spent catalyst stream to produce a mixture of another heated catalyst solid stream and a heated gas effluent; and
separating, in a separator operatively connected to a top portion of the radial flow moving bed reactor and a top portion of the riser, the other heated catalyst solid stream from the heated gas effluent.

13. The continuous process according to claim 12, wherein the combusting the spent catalyst stream comprising catalyst particles and solid carbon comprises contacting the spent catalyst stream with an oxidizing gas stream.

14. The continuous process according to claim 13, wherein the oxidizing gas stream comprises one of an inert gas, air, mixtures thereof or a steam and air mixture.

15. The continuous process according to claim 11, wherein the radial flow moving bed reactor comprises a center section, outer sections and an annular section located between the center section and each outer section, and the process comprises flowing the heated catalyst solid stream and the fresh catalyst into the annular section to form the moving catalyst bed; flowing the light hydrocarbon feed stream downward into the center section and radially outward into the annular section; and flowing the product effluent comprising hydrogen and the spent catalyst stream comprising catalyst particles and solid carbon flows from the annular section into the outer sections to an exit point in the radial flow moving bed reactor.

16. The continuous process according to claim 15, wherein the outer sections and the annular section have a first height and the center section has a second height less than the first height.

17. The continuous process according to claim 11, wherein the radial flow moving bed reactor comprises a center section, outer sections and an annular section located between the center section and each outer section, and the process comprises flowing the heated catalyst solid stream and the fresh catalyst into the annular section to form the moving catalyst bed; flowing the light hydrocarbon feed stream downward into the outer sections and radially inward into the annular section; and flowing the product effluent comprising hydrogen and the spent catalyst stream comprising catalyst particles and solid carbon flows from the annular section into the center section to an exit point in the radial flow moving bed reactor.

18. The continuous process according to claim 17, wherein the center section and the annular section have a first height and the outer sections have a second height less than the first height.

19. The continuous process according to claim 11, further comprising heating the moving catalyst bed to maintain a temperature of the moving catalyst bed at the temperature sufficient to crack the light hydrocarbon feed stream to produce the product effluent comprising hydrogen and the spent catalyst stream comprising catalyst particles and solid carbon using a heating unit located internally in the radial flow moving bed reactor.

20. The continuous process according to claim 11, wherein the heated catalyst solid stream has a temperature of from about 450° C. to about 1500° C., and the light hydrocarbon feed stream is a natural gas stream.
